(19) United States
(12) Patent Application Publication
(10) Pub. No.: US 2012/0061974 A1
(43) Pub. Date: Mar. 15, 2012

(54) CAVITY DOOR END PULL LATCH SET AND LOCK SET

(76) Inventors: Edward T. Laverty, Brisbane (AU); Michael David Swales, Riverview (AU)

(21) Appl. No.: 13/228,072

(22) Filed: Sep. 8, 2011

(30) Foreign Application Priority Data
Sep. 9, 2010 (AU) 2010904043

(51) Int. Cl. E05B 65/00; E05C 1/10; E05C 1/08

(52) U.S. Cl. 292/145; 292/138; 70/77

(57) ABSTRACT

The invention relates to a latch assembly for a cavity door. The latch assembly comprises a housing operable to mount the latch assembly within the cavity door. A latch operator is mounted relative to the housing for operating the latch assembly. A drive assembly is mounted for rotation within the housing and is responsive to operation of the latch operator. A slider is mounted relative to the housing for linear movement and is responsive to the rotation of the drive assembly. A latch bolt assembly is also provided which is movable between a first extended position and a second retracted position. Movement of the latch operator in a first direction causes the latch bolt assembly to be moved into the first position and movement of the latch operator in a second direction causes the latch bolt to be moved into the second position.

### FIELD OF THE INVENTION

The present invention relates to a cavity door end pull latch set and lock set. In some embodiments, the invention is directed to a latch for a cavity door, although the scope of the invention is not necessarily limited thereto.

### BACKGROUND

A cavity slider door is one where the opening panel slides into a cavity within the wall structure. They are used where space is limited as the space on either side of the doorway does not have to be free to accommodate the swinging leaf of a hinged door, and the wall space adjacent to the doorway is not taken up by the rails and guides of a traditional surface mounted sliding door.

One of the problems associated with cavity sliders is the limited space available for handles and locking hardware. Handles, mounting plates etc. cannot protrude more than a few millimetres, typically 3 mm from the surface of the panel to avoid fouling on the edges of the wall cavity into which the door is received when open.

A typical sliding door used in a residential dwelling will have a nominal thickness of 35 mm. The actual thickness can typically be as low as 32 mm. Specialty doors may have thicknesses up to 45 mm. The doors typically have a standard lock preparation consisting of a Ø54 mm hole bored laterally through the panel and a Ø25 mm hole bored longitudinally into the panel. The axes of these two holes intersect. The entire latching and locking mechanism must be accommodated within the two bored holes.

The use of cavity slider doors extends to access doors between the body of the house and the garage. These doors act as secondary entrance doors and therefore have a requirement for a high level of security. The standard preparation however allows limited space for a locking mechanism. There are currently no key operated latches or locks available for cavity slider doors that fit into the standard door preparation described above.

A further problem with cavity slider doors is the need to provide a means of withdrawing the door panel from within the cavity when it is to be closed. Typical solutions are a plain hole bored into the end face of the panel or a pivoted flap attached to the end face of the panel. These methods are typically uncomfortable to use or require the use of fingernails to extract the grip.

It is an aim of the invention to provide a cavity door end pull latch set and lock set which overcomes or ameliorates one or more of the disadvantages or problems described above, or which at least provides the consumer with a useful choice.

It will be clearly understood that any reference herein to background material or information, or to a prior publication, does not constitute an admission that any material, information or publication forms part of the common general knowledge in the art, or is otherwise admissible prior art, whether in Australia or in any other country.

### DESCRIPTION OF THE INVENTION

According to a first embodiment of the invention, there is provided a latch assembly for a cavity door, the latch comprising a housing adapted to mount the latch assembly within the cavity door, at least one latch operator for operation of the latch assembly and mounted relative to the housing, a drive assembly mounted for rotation within the housing responsive to operation of the at least one latch operator, a slider mounted relative to the housing for linear movement responsive to the rotation of the drive assembly, and a latch bolt assembly movable between a first extended position and a second retracted position, wherein movement of at least one of the at least one latch operator in a first direction causes the latch bolt to be moved into the first position and movement of at least one of the at least one latch operator in a second direction causes the latch bolt to be moved into the second position.

An embodiment of the invention may also be considered to reside broadly in a latch assembly for a cavity door, the latch assembly comprising a housing operable to mount the latch assembly within the cavity door, a latch operator mounted relative to the housing for operating the latch assembly, a drive assembly mounted for rotation within the housing responsive to operation of the latch operator, a slider mounted relative to the housing for linear movement responsive to the rotation of the drive assembly, and a latch bolt assembly movable between a first extended position and a second retracted position, wherein movement of the latch operator in a first direction causes the latch bolt assembly to be moved into the first position and movement of the latch operator in a second direction causes the latch bolt to be moved into the second position.

The present invention can also be used with sliding doors, hence, any reference to a cavity door can also be understood to be a reference to a sliding door.

In one embodiment, the housing may be a partial housing or may be partially open. The housing does not have to be an all enclosing housing. The housing may comprise escutcheons. The housing may be or include one or more escutcheon.

The housing may comprise two portions, each portion adapted to be provided on opposite sides of the door panel. The two portions of the housing may be attached either to each other or to the door panel by elongate screws. In this way, the distance between the two portions of the housing may be adjusted to fit doors of varying thicknesses. Thus, the invention provides the benefit of being adaptable to doors of different thicknesses.

Typically, the housing will be substantially circular when viewed from the side. A substantially circular housing may assist in the installation of the housing in a lock preparation of a door, given that the housing is often installed into a circular opening formed in the door. The housing preparation is usually a standard lock or latch preparation.

Typically, a substantially circular housing also enables the ‘hand’ of the latch to be selected simply by installing the ‘internal’ and ‘external’ sides of the housing on the desired sides of a cavity door and turning the housing in the required direction.

Typically, the housing will be formed of metal such as die cast metal, brass, steel etc. Alternatively the housing may be made from an alloy, polymer, ceramic, composite and/or any material according to a suitable materials selection chart.

The housing may be adapted such that various components of the latch or lock can be mounted in and/or to the housing. The housing may be adapted such that the housing attaches to or is operatively associated with a bolt tube, an end pull tube, a faceplate and/or (an) end pull core(s) for extra strength and/or security.

Typically, the housing comprises two substantially round escutcheons, an ‘internal’ escutcheon and an ‘external’ escutcheon. Normally the ‘internal’ escutcheon would be installed on an ‘internal’ side of a door and the ‘external’ escutcheon would be installed on an ‘external’ side of a door.

A drive assembly may be mounted for rotation within the ‘internal’ escutcheon. Typically, the ‘internal’ escutcheon would also be adapted such that a slider is mounted to the ‘internal’ escutcheon for linear movement relative to the ‘internal’ escutcheon.

Typically, the ‘internal’ escutcheon would also contain an aperture such that a latch operator may be operatively associated with the drive assembly through the escutcheon.

Typically, the ‘internal’ escutcheon would have apertures such that fasteners can be used to attach the ‘internal’ escutcheon to the ‘external’ escutcheon.

Typically, the ‘internal’ escutcheon would have one or more ribs, support members and/or the like to support the ‘internal’ escutcheon and/or the latch in the lock preparation.

Typically, the ‘external’ escutcheon would be adapted such that a latch operator may be mounted in or on the ‘external’ escutcheon. Preferably, the ‘external’ escutcheon also has an aperture such that the latch operator is accessible. Alternatively, if no latch operator is mounted in or on the ‘external’ escutcheon, the ‘external’ escutcheon may be an escutcheon without an aperture for latch operator access or a “blind” escutcheon.

Typically, the ‘external’ escutcheon has bores to accept the fasteners that attach the ‘internal’ escutcheon to the ‘external’ escutcheon. Typically, the threaded bores are long enough such that the distance between the ‘internal’ escutcheon and ‘external’ escutcheon may be adjusted to fit doors of varying thicknesses. The threaded bores are preferably provided in elongate fingers which extend from an inner surface of the ‘external’ escutcheon. These fingers preferably extend into the thickness of the door and normally are located on the escutcheon such that the fingers can be used to locate the housing relative to the door preparation.

According to a preferred embodiment, elongate fingers with or without threaded bores may be provided on either or both of the ‘internal’ or ‘external’ escutcheon. Typically the fingers will be provided on both and will be offset from one another such that when the two housing portions are located in the door, the fingers of the respective housing portions define a substantially circular space between them into which other components of the latch/lock are situated and within which movement may be guided.

No particular limitation should be placed on the invention by the use of the words ‘internal’ and ‘external’ to describe the escutcheons and/or sides, the escutcheons/sides may also be referred to as a first escutcheon/side and a second escutcheon/side.

In another embodiment, the latch assembly for a cavity door comprises at least one latch operator. The at least one latch operator may be operatively associated with a drive assembly.

The at least one latch operator may be a handle, thumb-turn, privacy barrel, key barrel, remote controlled operator, magnetically manipulated operator and/or any other operator that is known in the art. Normally the latch assembly for a cavity door comprises two latch operators. Any combinations of latch operators may be used on either side of the door, with a handle, thumb-turn, privacy barrel, a key barrel or the like on a first side of the latch assembly and a handle, thumb-turn, privacy barrel, a key barrel or the like on a second side of the latch assembly. Alternatively, the first side or the second side of the latch assembly may not include a latch operator. If there is more than one latch operator present and the first latch operator is a handle, thumb-turn or the like, movement of the other latch operator(s) may cause movement of the first latch operator.

Typically there would be a thumbturn on the first side and a key barrel on the second side.

Alternatively there may be a thumbturn on the first side and a privacy barrel on the second side.

Typically the thumb turn would be operatively associated with the drive assembly such that rotation of the thumb turn rotates the drive assembly.

For the key barrel and privacy barrel embodiments, each of these barrels will normally be located within a cylinder and associated with a cylinder cam. Typically, rotation of the key barrel rotates a cylinder cam. Alternatively if a privacy barrel is present, rotation of the privacy barrel rotates the cylinder cam. Normally the cylinder cam is operatively associated with the drive assembly such that rotation of the cylinder cam in a first direction rotates the drive assembly in a first direction and rotation of the cylinder cam in a second direction rotates the drive assembly in a second direction. It will also be appreciated that typically, due to the cam action, rotation of the cylinder cam may only rotate the drive assembly when the cylinder cam is operatively engaged with the drive assembly.

In one embodiment, the latch assembly for a cavity door includes a drive assembly. The drive assembly may be responsive to movement of the at least one latch operator, whatever the configuration of the latch operator. Where latch operators are provided on both sides of the door, each latch operator will typically be capable of initiating movement of the drive assembly, although the movement by one latch operator may be prevented by the other depending on the types of the respective latch operators.

The drive assembly may be mounted for rotation within the housing. The drive assembly normally includes a disc or similar which is mounted for rotation within the housing, typically guided rotation about the same axis as the latch operator. The drive assembly normally has a drive bar which is attached eccentrically to the disc. Typically, the disc is attached to a thumbturn latch operator via a centre pin or similar. Typically, the centre pin holds the thumbturn in place. Typically the centre pin projects through an aperture in the housing and is attached to the disc with a circlip. However, other means to achieve the same results are envisaged including the use of fasteners, locking pins, adhesives and/or the like.

Typically, different door thicknesses are accommodated by having the drive bar of sufficient length such that a cylinder cam (where provided on the opposite side of the door) can engage with the drive bar at different points along its length as the door thickness increases or decreases.

In one alternative embodiment, the drive assembly may be or include a key barrel or privacy barrel, located within a cylinder and associated with a cylinder cam. In this configuration, a barrel may be provided on both sides of the door.

The latch assembly for a cavity door also comprises a slider. The slider is preferably operatively associated with the drive assembly such that movement of the drive assembly results in linear movement of the slider relative to the housing.

The slider may be mounted for linear movement relative to the housing. The slider may contain biasing means to bias the drive assembly in either a first position or a second position. Alternatively, the biasing means may bias the drive assembly in a first direction relative to the slider. The biasing means may be a bow spring, a spring, resilient material, magnetic material and/or the like.

The slider is preferably operatively associated with a latch or lock bolt assembly. Normally, the slider engages with a tail bar and the tail bar is operatively associated with the latch or lock bolt assembly. Normally, the engagement with the tail bar is such that the tail bar can engage at different points along the slider so that the latch assembly can fit cavity doors of varying thicknesses.

The slider is preferably a substantially C-shaped or U-shaped body with one C-shaped or U-shaped edge abutting an inner surface of at least one of the housing portions. Typically the slider has an opening or cut out such that the tail bar can engage at different points along the length of the opening or cut out.

Typically the slider has an aperture through which the drive bar of the drive assembly can project. Normally, movement of the drive bar against the surrounds of the aperture causes linear movement of the slider relative to the housing. Typically, rotation of the drive assembly in a first direction causes linear movement of the slider in a first direction to a first position and rotation of the drive assembly in a second direction causes linear movement of the slider in a second direction to a second position.

The tail bar normally has a notch formed between a pair of spaced apart portions such that the tail bar can be slidingly attached to the slider by alignment of the notch with the opening or cut out in the slider.

The latch assembly also includes a latch or lock bolt assembly. The latch or lock bolt assembly may be guided by a bolt tube, typically provided on or engaging with a face plate of the latch or lock assembly. The bolt tube typically extends sufficiently to abut or to engage with the housing.

The latch or lock bolt assembly may comprise a latch or lock bolt. The latch bolt is typically movable between a first extended position and a second retracted position. The latch bolt is provided with or operatively associated with a tail bar, such that movement of the tail bar causes movement of the latch or lock bolt.

The latch or lock bolt assembly normally comprise at least one beak which is extendable and retractable with the extension and retraction of the latch or lock bolt from the face plate. A beak may also be referred to as a hook. The at least one beak may be biased by a biasing means into a retracted position relative to the latch or lock bolt. The at least one beak may be adapted to engage with the faceplate such that when the latch or lock bolt assembly moves into the first or extended position, the at least one beak is moved into an extended position relative to the bolt. In this position, the at least one beak preferably engages with a strike provided in the door jamb. Normally the at least one beak is adapted to engage with the strike when the bolt assembly partially projects from the face plate in a first extended position. Typically the bolt assembly has two beaks, one provided on either side of the latch or lock bolt and both extend and retract together.

Typically, when the bolt assembly is in a second retracted position, the beaks are not engaged with the faceplate and are biased into a retracted position by a spring.

The latch assembly for a cavity door may additionally include an end pull. The end pull may require an additional hole bored longitudinally into the door panel, substantially parallel with the latch or lock bolt. The end pull may be part of an integrated unit, which may also include the latch or lock bolt assembly. The integrated unit may fit into the door edge into two longitudinally drilled holes. The end pull may be of a push-push style.

The end pull may be at least partially contained within end pull cores. The end pull cores may be at least partially contained within an end pull tube. The end pull tube is typically formed with or engages with the faceplate.

The end pull is preferably adapted for movement to extend from the faceplate such that the door can be pulled from a cavity by a user or to be substantially flush with the faceplate. When the end pull is substantially flush with the faceplate, pressing the end pull may cause the end pull to extend from the faceplate. When the end pull is extended from the faceplate, pressing the end pull into the faceplate may move the end pull into a position substantially flush with the faceplate.

The extension and retraction of the end pull may be controlled by a heart cam. The end pull may be biased into the extended position by a spring. Typically, the end pull is at least partially retained in end pull cores by a cam spring that moves around a heart cam. Typically, the heart cam is adapted such that the cam spring can only substantially move around the heart cam in one direction. Typically the cam spring is biased against the heart cam and is adapted to move along ramps in the heart cam.

A faceplate is normally provided. The faceplate may have at least one aperture for the latch or lock bolt assembly and/or the end pull. The faceplate may have at least one aperture for fasteners such that the faceplate may be fastened to the latch or lock bolt tube, end pull tube, housing and/or the door.

A strike is typically provided in the latch/lock set to engage with the latch or lock bolt when extended. The strike may be provided with a box keeper to provide extra strength and/or security. If the latch assembly comprises an end pull, the strike may also have a protrusion such that when the cavity door is closed while the end pull is in the extended position, the protrusion will press the end pull into the retracted position. Typically, the strike is attached to a door jamb opposite the latch or lock bolt.

The components of the latch assembly for a cavity door are normally made of a suitable metallic material. Alternatively the components may be made from alloys, polymers, ceramics, composites and/or any material according to a suitable materials selection chart.

One important feature of the invention is that the latch assembly for a cavity door may be installed into a standard door preparation as used fro cylindrical locks. No particular limitation should be placed on the invention by the size of the standard lock preparation holes.

### BRIEF DESCRIPTION OF THE DRAWINGS

One or more preferred embodiments of the invention will now be described, by way of example only, with reference to the accompanying drawings in which:

FIG. 1 is an exploded view of a cavity door end pull latch set.

FIG. 2a is an isometric view of a cavity door end pull latch set from the external side.

FIG. 2b is an isometric view of a cavity door end pull latch set from the internal side.

FIGS. 3a-3f are various orthographic views of a cavity door end pull latch set.

FIGS. 4a-4g are various section views of a cavity door end pull latch set in the unlatched position.

FIGS. 5a-5g are various section views of a cavity door end pull latch set in the latched position.

FIG. 6 is an exploded view of a cavity door end pull latch set with a privacy barrel (cavity door end pull latch set).

FIG. 7a is an isometric view of a cavity door end pull latch set from the internal side.

FIG. 7b is an isometric view of a cavity door end pull latch set from the external side.

FIGS. 8a-8f are various orthographic views of a cavity door end pull latch set.

FIGS. 9a-9g are various section views of a cavity door end pull latch set in the unlatched position.

FIGS. 10a-10g are various section views of a cavity door end pull latch set in the latched position.

FIG. 11 is an exploded view of a cavity door end pull set.

FIG. 12a is an isometric view of a cavity door end pull set from the internal side.

FIG. 12b is an isometric view of a cavity door end pull set from the external side.

FIGS. 13a-13f are various orthographic views of a cavity door end pull set.

FIGS. 14a-14f are various orthographic views of a cavity door end pull set in the extended position.

FIGS. 15a-15d are various section views of a cavity door end pull set.

### BEST MODE

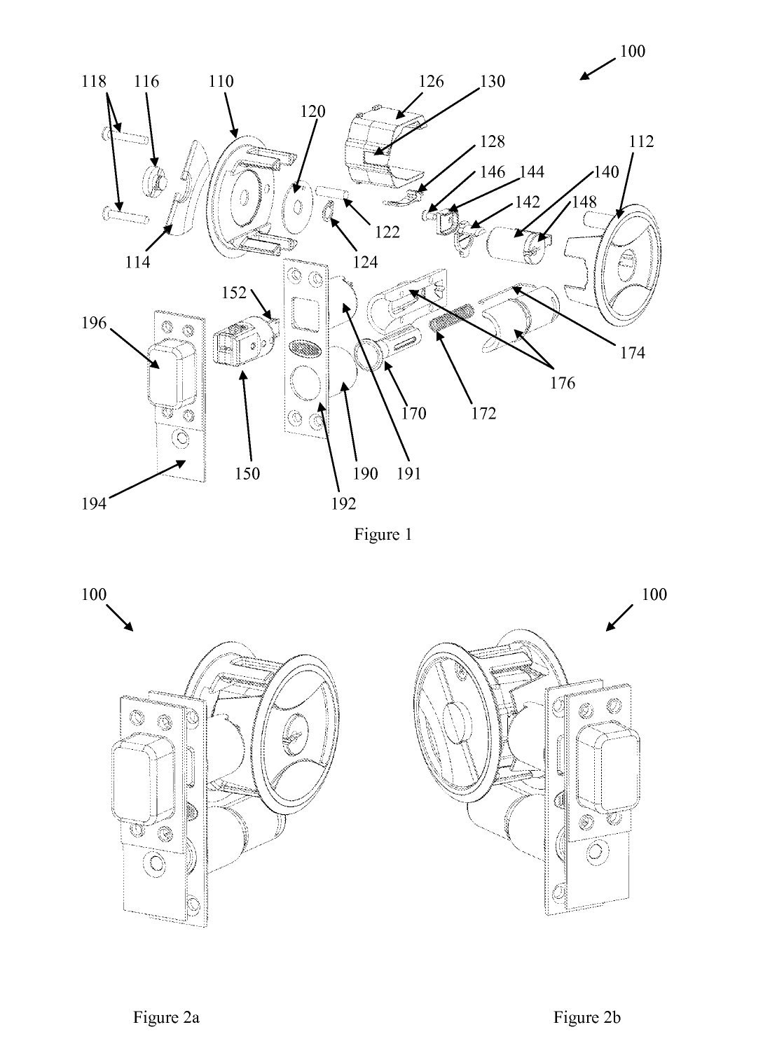

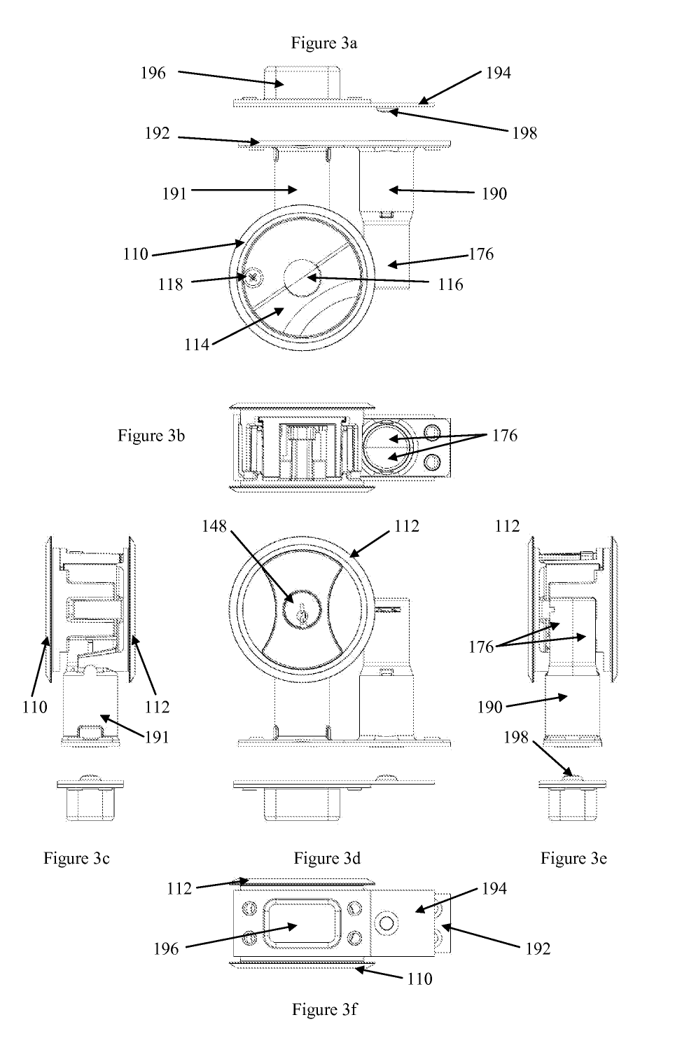

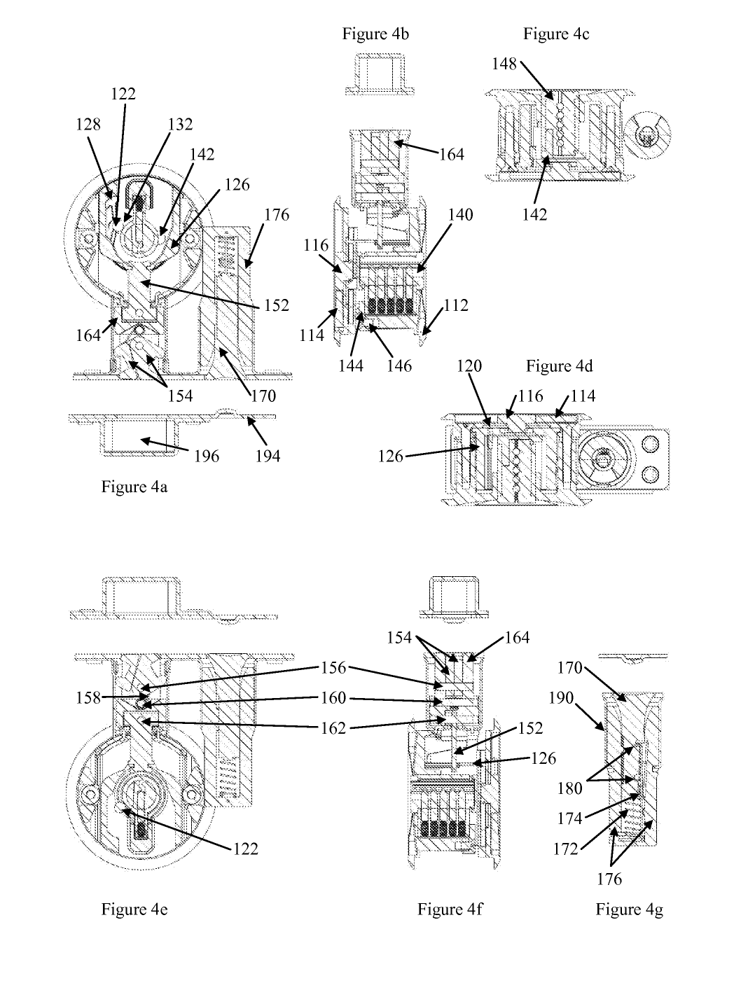

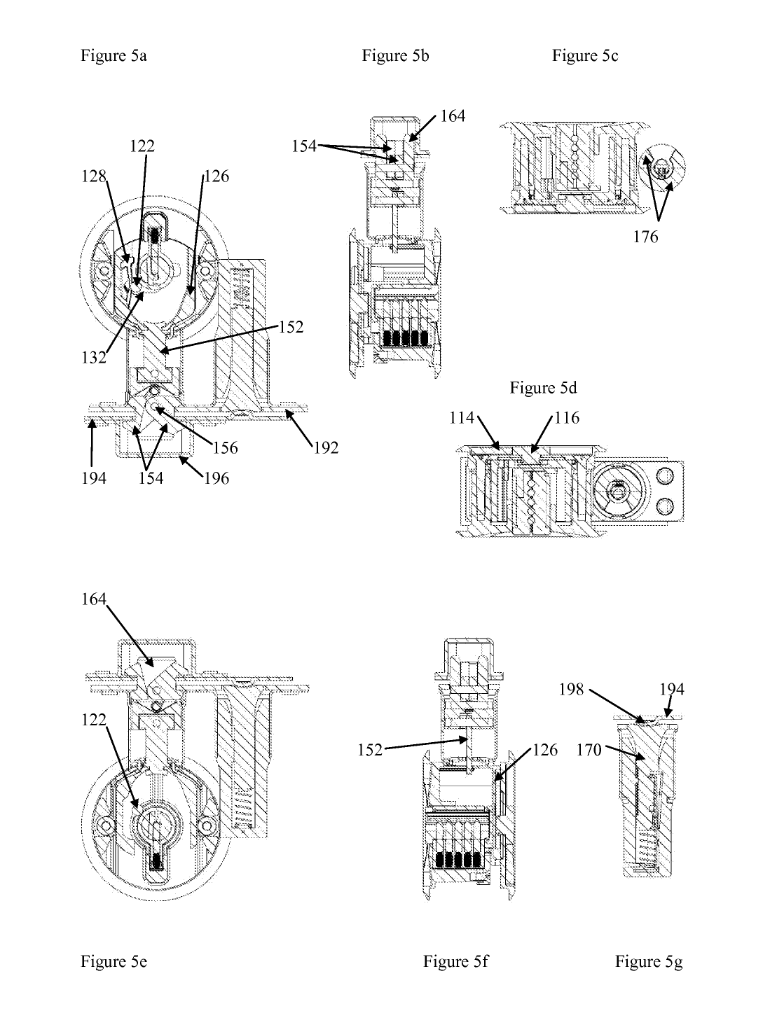

With reference to FIGS. 1 through to 5g (FIG. 1 shows an exploded view of a cavity door end pull latch set 100, this view best shows most of the individual components), there is shown a cavity door end pull latch set 100. Two escutcheons, the internal escutcheon 110 and the external escutcheon 112 act as a partial housing for the cavity door end pull latch set 100. Each escutcheon is normally mounted into a hole on opposing faces of a cavity door (not shown) (different sized escutcheons and holes can also be used). The distance between the internal escutcheon 110 and the external escutcheon 112 is adjustable to enable the cavity door end pull latch set 100 to fit cavity doors of varying thicknesses. The internal escutcheon 110 and the external escutcheon 112 are connected using escutcheon screws 118 which partially pass through the internal escutcheon 110 and threadably engage with the external escutcheon 112. A centre 116 connects a handle 114 through an opening in the internal escutcheon 110 to a disc 120. The centre 116 is engaged to the disc 120 by a circlip 124. The disc 120 has a drive bar 122. Rotation of the handle 114 rotates the centre 116 which rotates the disc 120, which moves the drive bar 122. A slider 126 is slideably mounted between the two escutcheons 110,112. The slider 126 has a side cut out 132 (best seen in FIGS. 4a and 5a), the drive bar 122 passes through the side cut out 132. Movement of the drive bar 122 moves the slider 126 relative to the two escutcheons 110,112. A bow spring 128 fitted to the slider 126 biases the drive bar 122 in either a first position (as can be seen in FIGS. 5a -5f where the cavity door end pull latch set 100 is in a latched position) or a second position (as can be seen in FIGS. 2a -4f where the cavity door end pull latch set 100 is in an unlatched position). The slider 126 has a cut out 130 which slidingly engages with a tail bar 152. The tail bar 152 engages with a bolt assembly 150. The tail bar 152 is attached to the bolt assembly 150 by a tail pin 162. It can be seen that the bolt assembly 150 is responsive to movement of the slider 126. The cut out 130 is of sufficient length such that the tail bar 152 can engage at different points along the length of the cut out 130 so that the cavity door end pull latch set 100 can fit cavity doors (not shown) of varying thicknesses.

The bolt assembly 150 is guided by a bolt tube 191. The bolt tube 191 engages with a face plate 192. The bolt assembly 150 partially projects from the face plate 192 in a first position (as can be seen in FIGS. 5a -5f where the cavity door end pull latch set 100 is in a latched position). When the bolt assembly 150 is in the first position, it can engage with a strike 194. The strike 194 is attached to a box keeper 196. This gives extra strength and security. The face plate 192 also engages with an end pull tube. The end pull tube holds two end pull cores 176. The end pull cores 176 house an end pull 170, a spring 172 and a cam spring 174. The end pull mechanism will be described in more detail below.

The cavity door end pull latch set 100 further comprises a cylinder 140. The cylinder 140 is retained relative to the external escutcheon 112 by a cylinder retainer 144 and a retainer screw 146 which attaches the cylinder retainer 144 to the external escutcheon 112. A key barrel 148 is mounted for rotation in the cylinder 140. It will be appreciated that the key barrel 148 will only be rotatable relative to the cylinder 140 by a correct key (not shown) inserted into the key barrel 148. A cylinder cam 142 engages with the key barrel such that rotation of the key barrel 148 causes rotation of the cylinder cam 142. The cylinder cam 142 engages with the drive bar 122 such that sufficient rotation of the cylinder cam 142 in a first direction moves the drive bar 122 into a first position (the first position of the drive bar 122 can be seen in FIGS. 5a -5f where the cavity door end pull latch set 100 is in a latched position) and sufficient rotation of the cylinder cam 142 in a second direction moves the drive bar 122 into a second position (the second position of the drive bar 122 can be seen in FIGS. 4a -4f where the cavity door end pull latch set 100 is in an unlatched position). The drive bar 122 is of sufficient length such that the cylinder cam 142 can engage at different points along the length of the drive bar 122 so that the cavity door end pull latch set 100 can fit cavity doors (not shown) of varying thicknesses.

The bolt assembly 150 comprises a bolt 164. The bolt 164 is of robust construction and encloses (in the retracted position) two beaks 154 (these can also be called hooks). The two beaks 154 are rotatably attached to the bolt 164 by a high strength beak pin 156. A spring 158 biases the two beaks 156 into the retracted position (this can be best seen in FIGS. 4a-4f). The spring 158 is held in position by a spring pin 160. When the bolt assembly 150 moves to the first position (as can be seen in FIGS. 5a -5f where the cavity door end pull latch set 100 is in a latched position), the beaks 156 engage with the inner face of the face plate 192 to rotate such that the beaks 156 can engage with the strike 194. When the bolt assembly 150 moves to the second position (as can be seen in FIGS. 4a -4f where the cavity door end pull latch set 100 is in an unlatched position), the beaks 156 are biased into the retracted position by the spring 158 and the cavity door (not shown) can be opened.

In practice, the cavity door end pull latch set 100 comprises three sub assemblies (the external escutcheon assembly and the internal escutcheon assembly as well as the latch/lock bolt assembly). Each assembly is mounted into a hole in a door on opposing faces (not shown). The external escutcheon assembly comprises the external escutcheon 112, cylinder 140, cylinder cam 142, cylinder retainer 144, retainer screw 146 and key barrel 148. The internal escutcheon assembly comprises the internal escutcheon 110, thumbturn 114, centre 116, disc 120, drive bar 122, circlip 124, slider 126 and the bow spring 128. The bolt tube 191, end pull tube 190, bolt assembly 150, tail bar 152, end pull 170, spring 172, cam spring 174 and end pull cores 176 are mounted in holes bored longitudinally into the door (not shown). The tail bar 152 is slidingly fit to the cut out 130 of the slider 126 during installation. Screws 118 fix the two sub assemblies together. The screws 118 are of sufficient length such that the two sub assemblies can fit cavity doors (not shown) of varying thicknesses.

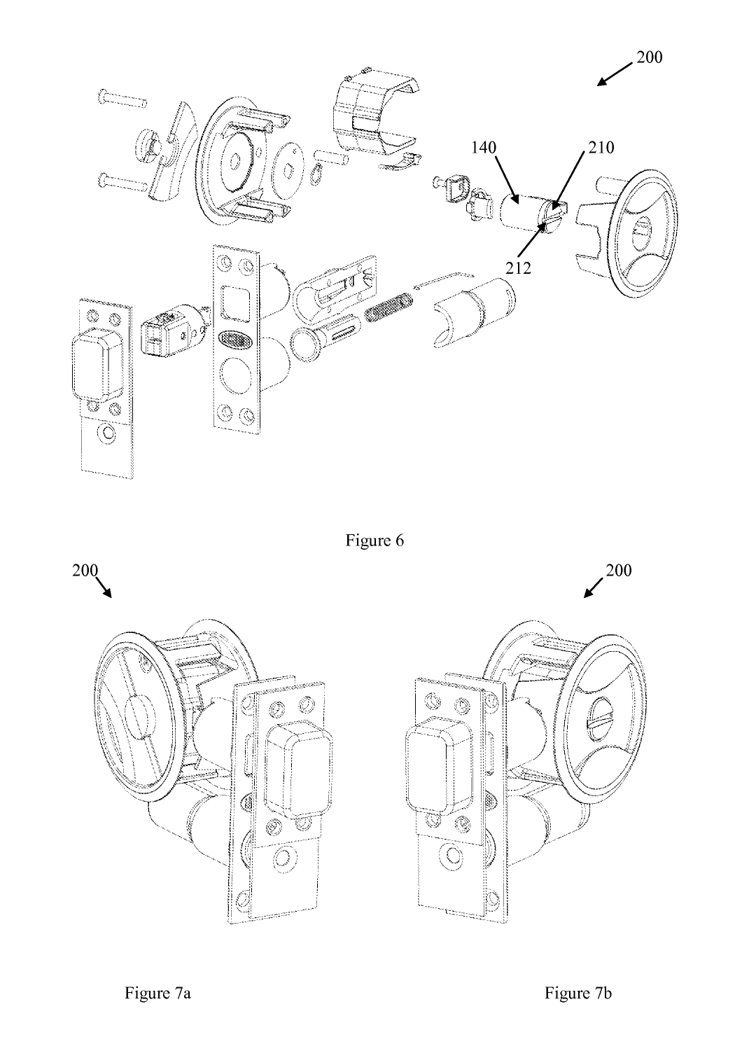

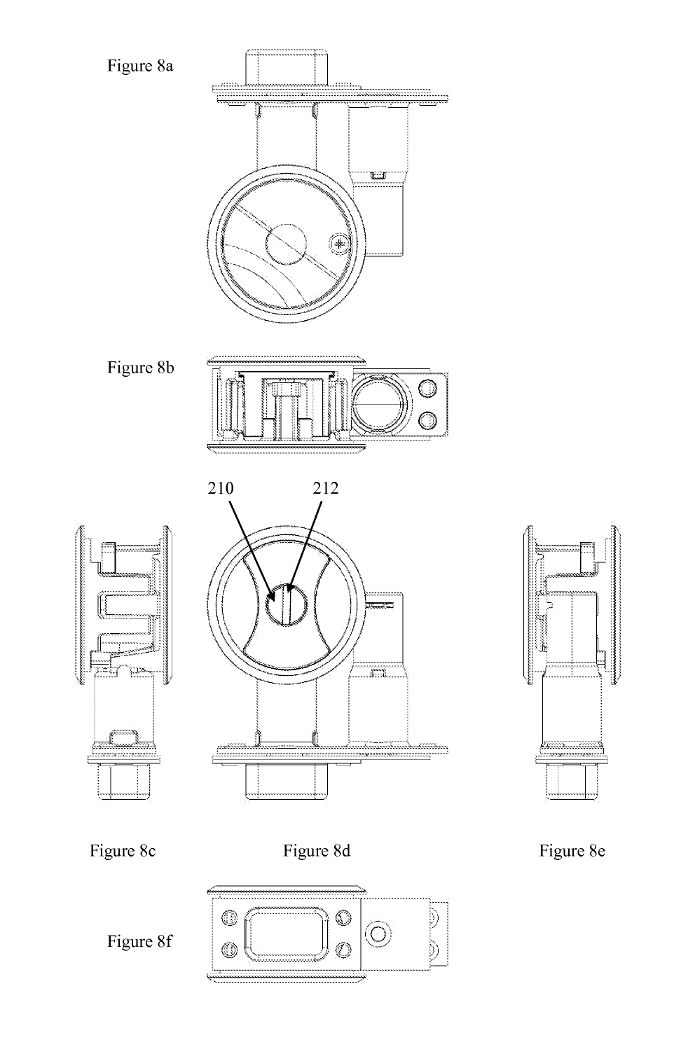

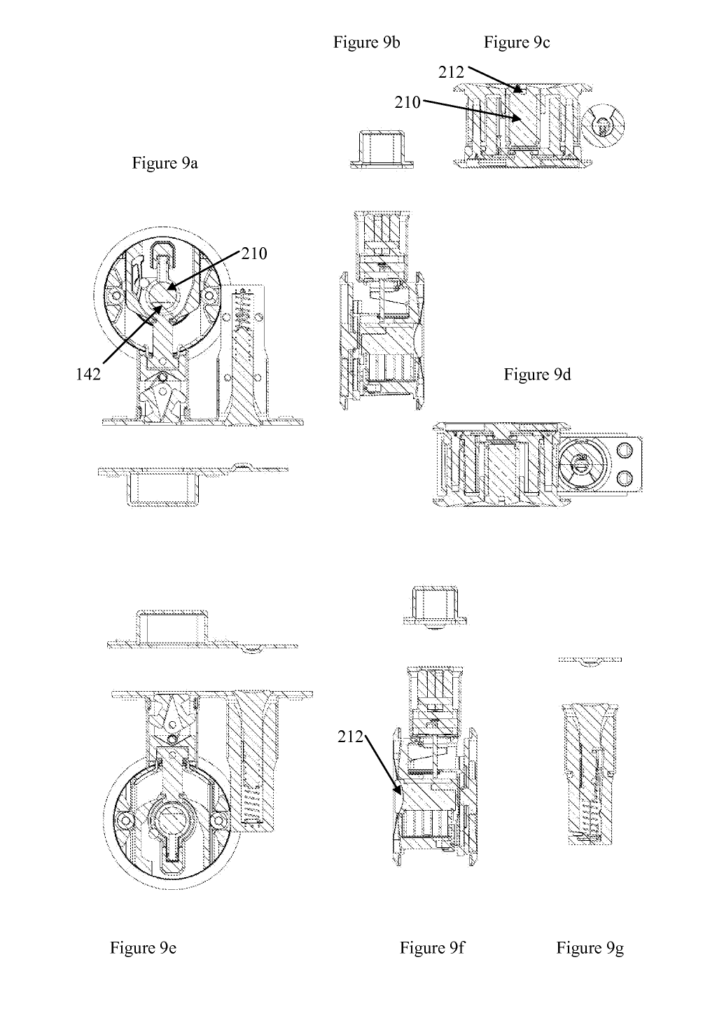

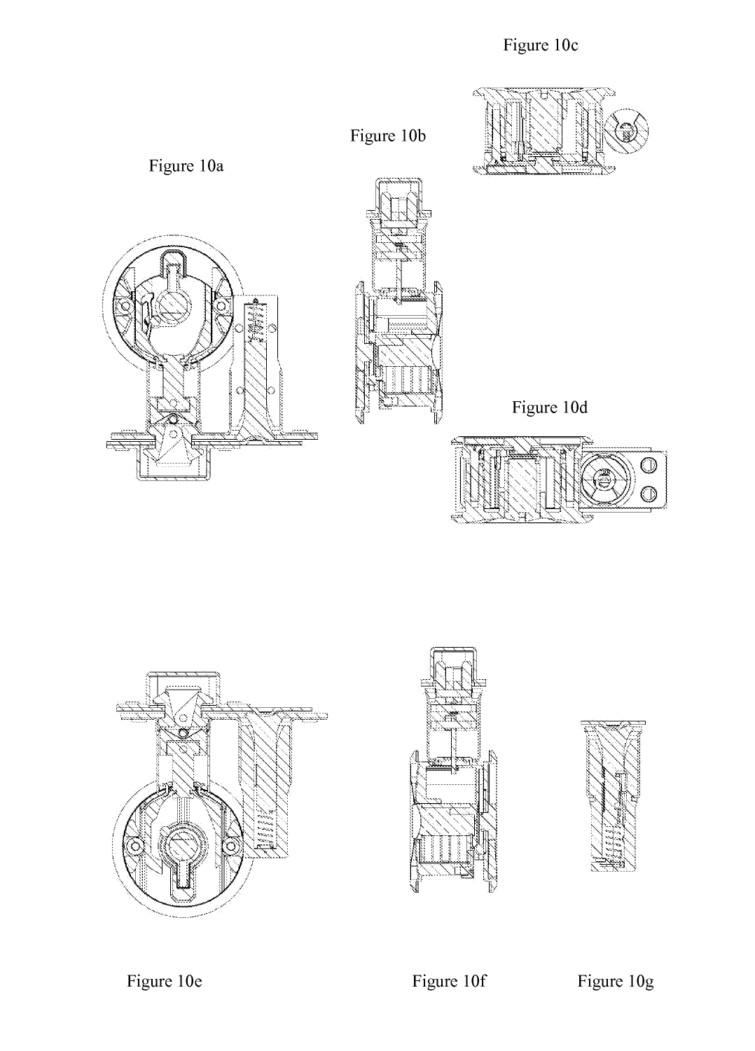

With reference to FIGS. 6 through to 10g, there is shown a cavity door end pull latch set 200, this latch set is almost identical to the cavity door end pull latch set 100 shown in FIGS. 1 through to 5g, the only difference is that the key barrel 148 shown in FIGS. 1- 5f has been replaced by a privacy barrel 210. The privacy barrel 210 has a slot 212 which can be operated by a screw driver, coin or the like (not shown) to rotate the privacy barrel 210.

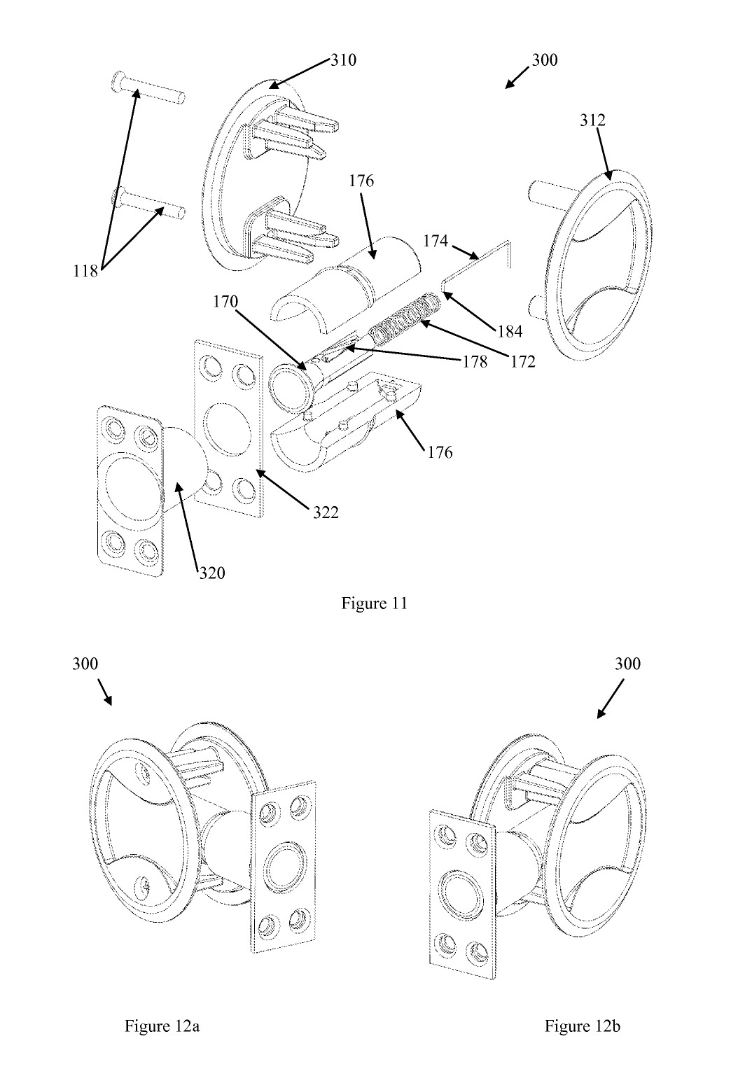

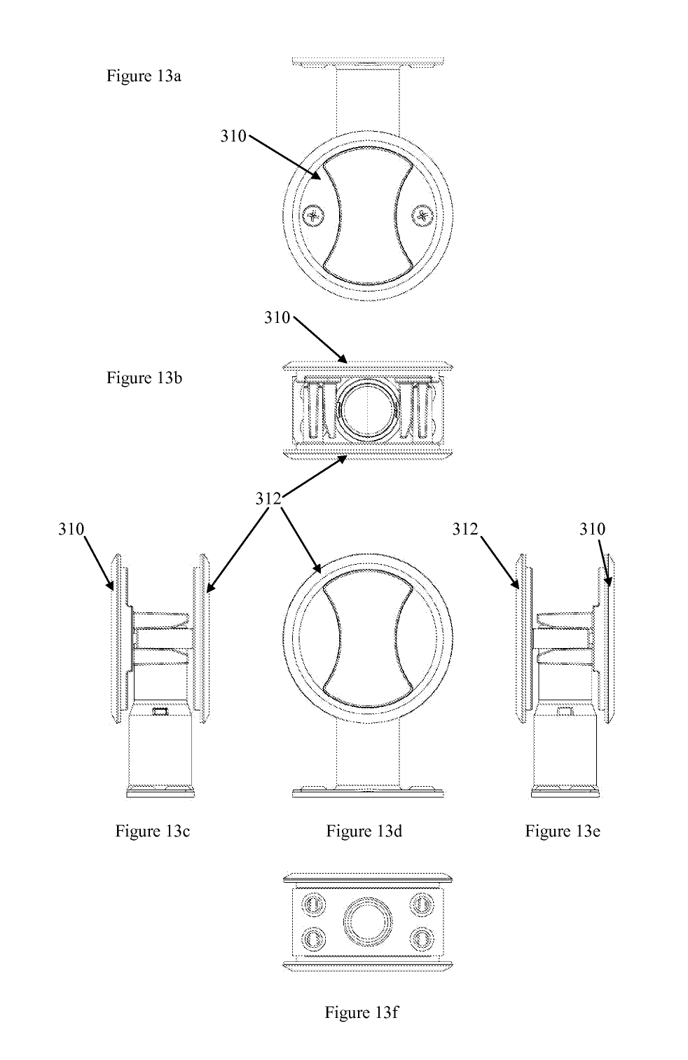

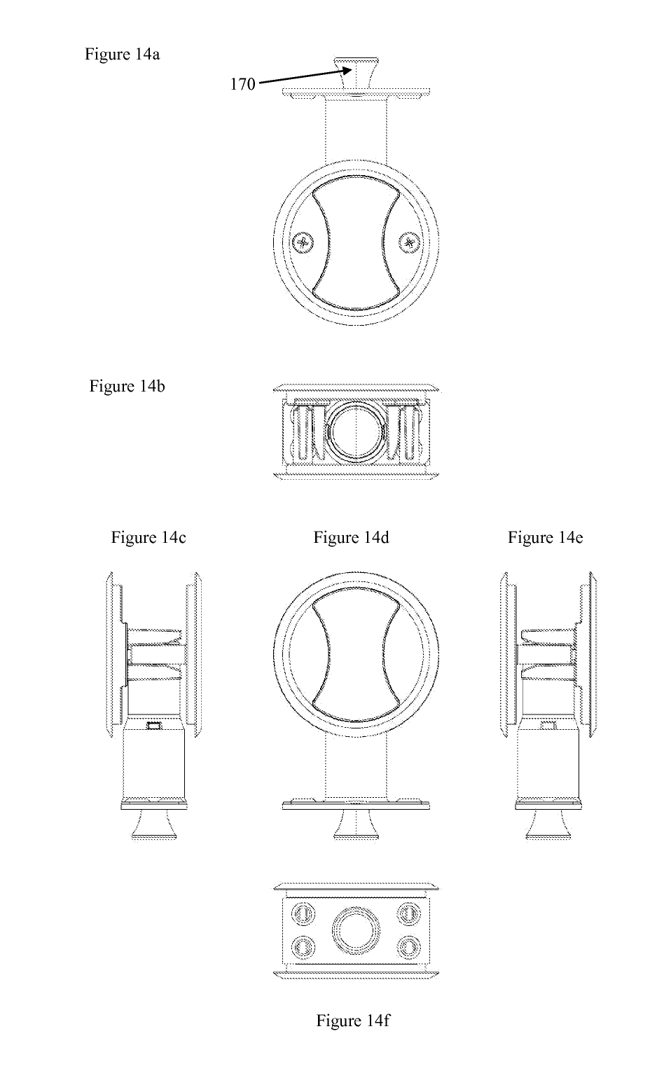

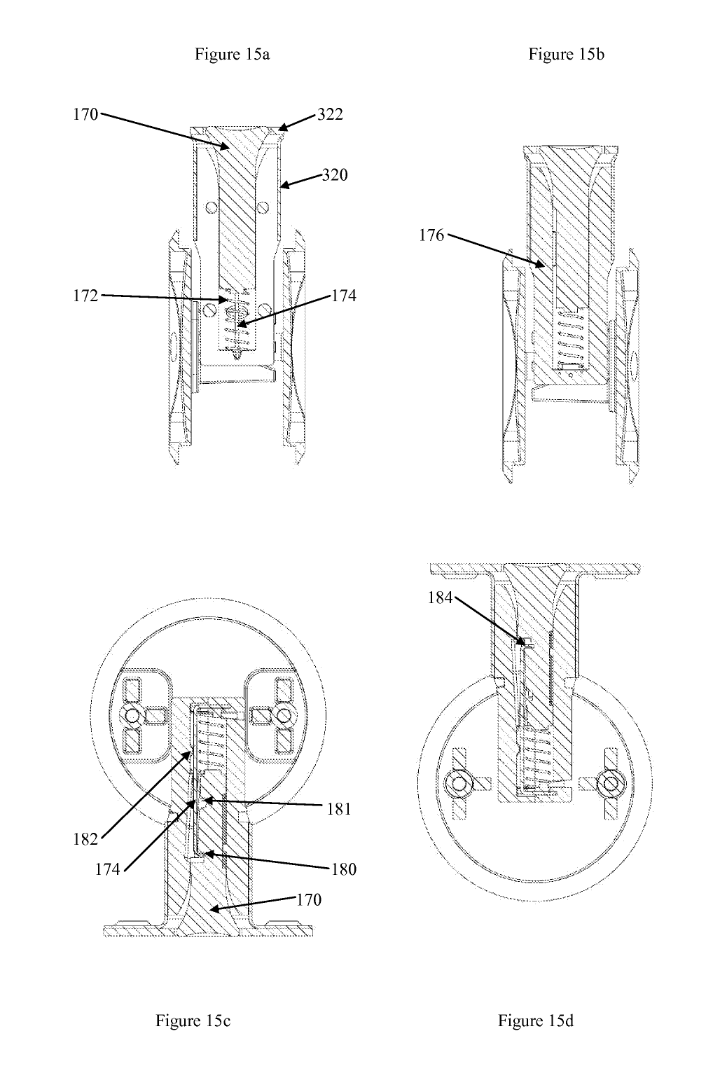

With reference to FIGS. 11 through to 15d, there is shown a cavity door end pull set 300. The cavity door end pull set 300 comprises an internal escutcheon 310 and an external escutcheon 312. The distance between the internal escutcheon 310 and the external escutcheon 312 is adjustable to enable the cavity door end pull set 300 to fit cavity doors of varying thicknesses. The internal escutcheon 310 and the external escutcheon 312 are connected using escutcheon screws 118 which partially pass through the internal escutcheon 310 and threadably engage with the external escutcheon 312. The cavity door end pull set 300 further comprises a face plate 322 and an end-pull tube 320. The end pull cores 176 are mounted in the end-pull tube 320. The end pull 170, spring 172, cam spring 174 and end pull cores 176 are the similar to those used with the cavity door end pull latch set 100 in FIGS. 1 through to 5g and the cavity door end pull latch set 200 in FIGS. 6 through to 10g. The end pull 170 is mounted in the end pull cores 176. The end pull 170 is biased to the extended position by a spring 172. The spring is mounted in the end pull cores 176. The end pull 170 is of a push-push style. The pull 170 is held in position by a cam spring 174. The cam spring 174 has a locating end 184 that is adapted to move around a heart cam 178. The locating end 184 engages with heart cam stops 180, 181 to hold the cam spring 174 in position. The locating end 184 can only move in one direction around a series of ramps (not shown) and heart cam stops 180, 181 which make up the heart cam 178, this permits the extension and retention of the end pull 170. The cam spring 174 is biased by a protrusion 182 such that the locating end 184 is biased against the ramps (not shown) of the heart cam 178. In the retracted position (best seen in FIGS. 15a-15d), pressing the end pull 170 causes the locating end 184 to move from stop 180 along a first ramp (not shown) to the start of a second ramp (not shown), when the end pull 170 is released, the spring 172 biases the end pull 170 to the extended position, causing the locating end 184 to move along the second ramp (not shown) to a heart cam stop 181. In the extended position, pressing the end pull 170 causes the locating end 184 to move from heart cam stop 181 along a third ramp (not shown) to the start of a fourth ramp (not shown), when the end pull 170 is released, the spring 172 biases the end pull 170 towards the extended position, causing the locating end 184 to move along the fourth ramp (not shown) to the heart cam stop 180. When the locating end 184 moves from the first ramp (not shown) to the second ramp (not shown), the locating end 184 ‘falls’ down to the second ramp (not shown), the locating end 184 is biased down preventing the locating end 184 from moving back along the first ramp (not shown), thus the locating end has to move along the second ramp (not shown). A similar movement occurs when the locating end 184 moves from the second ramp (not shown) to the heart cam stop 181 (which is also the start of the third ramp (not shown)), when the locating end 184 moves from the third ramp (not shown) to the fourth ramp (not shown) and when the locating end 184 moves from the fourth ramp (not shown) to the heart cam stop 180 (which is also the start of the first ramp (not shown)). From this it can be appreciated that when the end pull is in the retracted position, one push (of the end pull 170) extends the end pull 170 enabling the door (not shown) to be pulled out from the cavity (not shown), and a second push (of the end pull 170) returns the end pull 170 to its original retracted position.

The foregoing embodiments are illustrative only of the principles of the invention, and various modifications and changes will readily occur to those skilled in the art. The invention is capable of being practiced and carried out in various ways and in other embodiments. It is also to be understood that the terminology employed herein is for the purpose of description and should not be regarded as limiting.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

This application claims priority of Australian Patent Application No. 2010/904043 filed Sep. 9, 2010, which is hereby incorporated by reference in its entirety.

1. A latch assembly for a cavity door, the latch assembly comprising a housing operable to mount the latch assembly within the cavity door, a latch operator mounted relative to the housing for operating the latch assembly, a drive assembly mounted for rotation within the housing responsive to operation of the latch operator, a slider mounted relative to the housing for linear movement responsive to the rotation of the drive assembly, and a latch bolt assembly movable between a first extended position and a second retracted position, wherein movement of the latch operator in a first direction causes the latch bolt assembly to be moved into the first position and movement of the latch operator in a second direction causes the latch bolt to be moved into the second position.

2. A latch as claimed in claim 1, wherein there is at least one latch operator, and at least one of the latch operator(s) is a handle.

3. A latch as claimed in claim 1, wherein there is at least one latch operator, and at least one of the latch operator(s) is a thumb-turn.

4. A latch as claimed in claim 1, wherein there is at least one latch operator, and at least one of the latch operator(s) is a privacy barrel.

5. A latch as claimed in claim 1, wherein there is at least one latch operator, and at least one of the latch operator(s) is a key barrel.

6. A latch as claimed in claim 1, wherein the latch can be installed in a standard lock preparation of a door.

7. A latch as claimed in claim 1, wherein the housing is adjustable to fit within cavity doors of varying thicknesses.

8. A latch as claimed in claim 1, wherein the latch comprises an end pull.

9. A latch as claimed in claim 8, wherein the end pull is a push-push type end pull.
